(19) United States
(12) Patent Application Publication
(10) Pub. No.: US 2026/0162227 A1
(43) Pub. Date: Jun. 11, 2026

(54) GENERATING PHYSICAL COMPONENTS BASED ON BOUNDARY POINTS AND MACHINE LEARNING MODELS

(71) Applicant: VOLKSWAGEN AKTIENGESELLSCHAFT, WOLFSBURG (DE)

(72) Inventors: Adam Coogan, San Francisco, CA (US); Dhanashree Balaram, Fremont, CA (US); Megan Hardy, San Francisco, CA (US)

(21) Appl. No.: 18/972,635

(22) Filed: Dec. 6, 2024

(51) Int. Cl. G06T 5/60; G06T 5/70; G06T 17/00

(52) U.S. Cl. CPC G06T 5/60; G06T 5/70; G06T 17/00; G06T 2207/10028; G06T 2207/20081; G06T 2210/56

(57) ABSTRACT

A method of generating a physical component is disclosed. The method includes generating an input point cloud comprising a first set of boundary points and a first set of interior points and a second set of interior points. The first set of boundary points and the first set of interior points are associated with a first physical component. Each point in the input point cloud comprises a coordinate and a type indicator. The method also includes generating a component point cloud based on the input point cloud and a denoising diffusion probabilistic model (DDPM). The component point cloud represents a second physical component.

### TECHNICAL FIELD

Aspects of the present disclosure relate to generating physical components, and more particularly, to generating physical components and/or designs for physical components based on machine learning models.

### BACKGROUND

Devices and/or apparatus are often composed or built from multiple physical components (e.g., parts, elements, members, etc.). The physical components are often designed, created, etc., by users (e.g., engineers) based on various specifications and/or constraints. For example, a physical component may be designed such that the physical component has a certain size, shape, geometry, etc. In another example, a physical component may be designed to fit into or interface/interact with another physical component.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system architecture, in accordance with one or more embodiments of the present disclosure.

FIG. 2 is a diagram illustrating an example component generation system, in accordance with one or more embodiments of the present disclosure.

FIG. 3 is a diagram illustrating an example point cloud, in accordance with one or more embodiments of the present disclosure.

FIG. 4A is a diagram illustrating an example point cloud, in accordance with one or more embodiments of the present disclosure.

FIG. 4B is a diagram illustrating an example point cloud, in accordance with one or more embodiments of the present disclosure.

FIG. 4C is a diagram illustrating an example point cloud, in accordance with one or more embodiments of the present disclosure.

FIG. 5 is a flow diagram of a method for generating a physical component, in accordance with one or more embodiments of the present disclosure.

FIG. 6 is a flow diagram of a process for training a component generation system, in accordance with one or more embodiments of the present disclosure.

FIG. 7 is a block diagram of an example computing device that may perform one or more of the operations described herein, in accordance with some embodiments of the present disclosure.

### DETAILED DESCRIPTION

As discussed above, devices and/or apparatus are often composed or built from multiple physical components (e.g., parts, elements, members, etc.). The physical components are often designed, created, etc., by users (e.g., engineers) based on various specifications and/or constraints. Generating and/or designing new physical components may be a difficult and/or time-consuming process. For example, an engineer may manually create computer aided drafting figures/drawings for a physical component. The engineer may also need to check whether the physical components meet various specifications.

The examples, implementations, and embodiments described herein may help address these issues, among others, when generating, creating, designing, etc., physical components (e.g., new physical components). In one embodiment, a component generation system generates new physical components (e.g., generates point clouds representing the physical components) based on various machine learning models (e.g., a diffusion denoising probabilistic model, etc.) and based on different types, categories, classifications, etc., of points in the point clouds. For example, a point may be classified as a boundary point or an interior point, as discussed in more detail below. The component generation system may also generate the new physical components based on existing physical components. For example, a new physical component may include portions or the entirety of an existing physical component.

In one embodiment, the component generation system may simplify or streamline the process of generating, creating, designing, physical components. For example, rather than using a manual process for generating or creating physical components, the component generation system may apply machine learning models to generate (e.g., design) the physical components automatically. The component generation system may generate new physical components more quickly, efficiently, and with less expense than previous processes/methods.

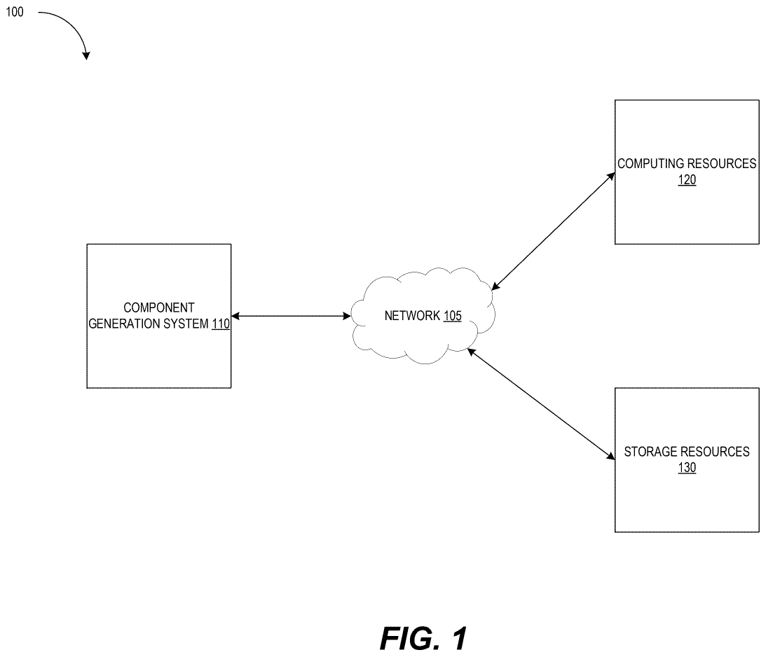

FIG. 1 is a block diagram that illustrates an example system architecture 100, in accordance with some embodiments of the present disclosure. The system architecture 100 includes network 105, a component generation system 110, computing resources 120, and storage resources 130. Network 105 may interconnect the component generation system 110, the computing resources 120, and/or the storage resources 130. Network 105 may be a public network (e.g., the internet), a private network (e.g., a local area network (LAN) or wide area network (WAN), or a combination thereof. In one embodiment, network 105 may include a wired or a wireless infrastructure, which may be provided by one or more wireless communications systems, such as a wireless fidelity (Wi-Fi) hotspot connected with the network, a cellular system, and/or a wireless carrier system that can be implemented using various data processing equipment, communication towers (e.g., cell towers), etc. Network 105 may carry communications (e.g., data, message, packets, frames, etc.) between the component generation system 110, the computing resources 120 and/or the storage resources 130.

The computing resources 120 may include computing devices which may include hardware such as processing devices (e.g., processors, central processing units (CPUs), processing cores, graphics processing units (GPUS)), memory (e.g., random access memory (RAM), storage devices (e.g., hard-disk drive (HDD), solid-state drive (SSD), etc.), and other hardware devices (e.g., sound card, video card, etc.). The computing devices may comprise any suitable type of computing device or machine that has a programmable processor including, for example, server computers, desktop computers, rackmount servers, etc. In some examples, the computing devices may include a single machine or may include multiple interconnected machines (e.g., multiple servers configured in a cluster, cloud computing resources, etc.).

The computing resources 120 may also include virtual environments. In one embodiment, a virtual environment may be a virtual machine (VM) that may execute on a hypervisor which executes on top of the OS for a computing device. The hypervisor may also be referred to as a virtual machine monitor (VMM). A VM may be a software implementation of a machine (e.g., a software implementation of a computing device) that includes its own operating system (referred to as a guest OS) and executes application programs, applications, software. The hypervisor may be a component of an OS for a computing device, may run on top of the OS for a computing device, or may run directly on host hardware without the use of an OS. The hypervisor may manage system resources, including access to hardware devices such as physical processing devices (e.g., processors, CPUs, etc.), physical memory (e.g., RAM), storage device (e.g., HDDs, SSDs), and/or other devices (e.g., sound cards, video cards, etc.). The hypervisor may also emulate the hardware (or other physical resources) which may be used by the VMs to execute software/applications. The hypervisor may present other software (i.e., “guest” software) the abstraction of one or more virtual machines (VMs) that provide the same or different abstractions to various guest software (e.g., guest operating system, guest applications). A VM may execute guest software that uses an underlying emulation of the physical resources (e.g., virtual processors and guest memory).

In another embodiment, a virtual environment may be a container that may execute on a container engine which executes on top of the OS for a computing device, as discussed in more detail below. A container may be an isolated set of resources allocated to executing an application, software, and/or process independent from other applications, software, and/or processes. The host OS (e.g., an OS of the computing device) may use namespaces to isolate the resources of the containers from each other. A container may also be a virtualized object similar to virtual machines. However, a container may not implement separate guest OS (like a VM). The container may share the kernel, libraries, and binaries of the host OS with other containers that are executing on the computing device. The container engine may allow different containers to share the host OS (e.g., the OS kernel, binaries, libraries, etc.) of a computing device. The container engine may also facilitate interactions between the container and the resources of the computing device. The container engine may also be used to create, remove, and manage containers.

The storage resources 130 may include various different types of storage devices, such as hard disk drives (HDDs), solid state drives (SSD), hybrid drives, storage area networks, storage arrays, etc. The storage resources 130 may also include cloud storage resources or platforms which allow for dynamic scaling of storage space.

Although the computing resources 120 and the storage resources 130 are illustrated separate from the component generation system 110, one or more of the computing resources 120 and the storage resources 130 may be part of the component generation system 110 in other embodiments. For example, the component generation system 110 may include both the computing resources 120 and the storage resources 130.

As discussed above, designing, creating, generating, etc., new physical components (e.g., a door frame, a window, a hinge, a joint, etc.) to be used in a larger device/apparatus (e.g., a vehicle, an electronic device, etc.) is often a manual process that is performed by users, such as design engineers, mechanical engineers, etc. For example, an engineer may obtain the specifications and manually design, draw, etc., a new physical component that satisfies the various specifications. The engineer may need to manually verify that the physical component satisfies the various specifications. The engineer may also need to confirm that the physical component is able to fit within and/or interface/connect with other physical components.

In one embodiment, the component generation system 110 may allow for the generation of new or novel physical components that conform to various specifications, conditions, parameters, etc. The component generation system 110 may automatically generate and/or create new physical components and/or designs for new physical components using a denoising diffusion probabilistic model (DDPM). The new physical components may be based on existing/previous physical components. Portions of the new physical component may be based on and/or may include an existing/base physical component (e.g., may include the entire existing/base physical component or portions of the existing/base physical component). The component generation system 110 may allow for a more streamlined, more automatic (e.g., partially or fully automated), faster, and/or more efficient generation, creation, design, etc., of new physical components. This may allow new physical components to be designed, created, etc., more quickly and efficiently.

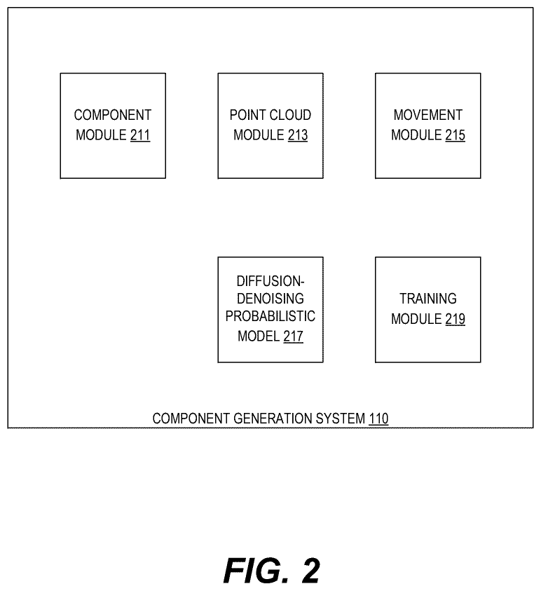

FIG. 2 is a diagram illustrating an example component generation system 110, in accordance with one or more embodiments of the present disclosure. The component generation system 110 may include a component module 211, a point cloud module 213, a movement module 215, DDPM 217, and a training module 219. Each of the component module 211, the point cloud module 213, the movement module 215, the DDPM 217, and the training module 219 may be a combination of hardware, software, and firmware. In addition, any of the component module 211, the point cloud module 213, the movement module 215, the DDPM 217, and the training module 219 may be combined together, divided into other modules, and/or distributed over multiple computing devices. Furthermore, any of the component module 211, the point cloud module 213, the movement module 215, the DDPM 217, and the training module 219 may be located in cloud computing platforms and/or cloud storage platforms.

As discussed above, the component generation system 110 may generate, create, design, etc., components that may be used in various apparatuses or devices. A physical component may be any object that may be included in another device/apparatus, may interface and/or connect with other objects, etc. For example, the component generation system 110 may generate a new physical component that will be included in a vehicle (e.g., may create a window that may be installed included in the vehicle when the vehicle is manufactured). In one embodiment, the new physical component generated by the component generation system may be based on and/or may include portions of an existing/previous physical component. For example, a user, designer, engineer, etc., may want to use a portion of a previous physical component to help ensure compatibility of the new physical component with other components.

In one embodiment, a new physical component and/or an existing/previous physical component may be represented using a point cloud. A point cloud may be set of data points in space (e.g., one or more points in Cartesian space). Generally, each point in the point cloud may have or may be associated with a set of Cartesian coordinates (X, Y, Z). A point cloud that includes points in Cartesian space may be referred to as a 3-dimensional (3D point cloud). A point cloud may include any number of points (e.g., tens, hundreds, thousands, millions, etc., of points).

A point cloud for a physical component (e.g., a point cloud that represents the physical component) may include different types of points. A first type of point may be referred as a boundary point. In one embodiment, boundary points may be points that are on outer or exposed surfaces of the physical component and/or may be points are located on/near the boundaries (e.g., edges, perimeters, borders, etc.) of the physical component. A second type of point may be referred to as an interior point. In one embodiment, interior points may be points that are within a physical component. For example, an interior point may be located within the material (e.g., metal, polymer, plastic, etc.) that constitutes the physical component (e.g., the materials that the physical component is composed or made of). In another example, an interior point may be a point whose location is conditioned, controlled, or based on one or more boundary points. In a further example, an interior point may be a point that is located on one side of one or more boundary points.

In one embodiment, the component module 211 may generate a point cloud and/or a set of points for an existing/previous physical component. For example, the component module 211 may use images, specification files, and/or other data that may describe the shape, dimensions, design, features, and/or other physical/geometric properties of the existing/previous physical component. The component module 211 may generate a point cloud that may represent the existing/previous physical component based on the images, specification files, and/or other data. For example, the component module 211 may include a machine learning model (e.g., a convolutional neural network, a recurrent neural network, a large language model, or some other appropriate model) that processes the set of specifications and generates a point cloud that represents the existing/previous physical component. The point cloud generated by the component module 211 may be referred to as an initial point cloud, as starting point cloud, a base point cloud, etc.

As discussed above, a point cloud includes multiple points and each point includes a coordinate for the point cloud. In one embodiment, point clouds may be modified, augmented, enhanced, by the component generation system 110. In addition to the coordinates (e.g., Cartesian coordinates, XYZ coordinates, etc.), the component module 211 may include and/or may be associated with a type indicator (or some other flag/value) that may indicate the type of the point. Each type indicator may indicate whether a corresponding point is a boundary point or an interior point, based on the value of type indicator. For example, a value of 0 for the type indicator for a particular point may indicate that the particular point is an interior point. In another example, a value of 1 for the type indicator for a particular point may indicate that the particular point is a boundary point. Any appropriate value for the type indicator may be used to indicate whether a particular point is a boundary point or an interior point.

In one embodiment, the component module 211 may optionally distribute points that represent the existing/previous physical component, randomly within the point cloud. In particular, the component module 211 may move, position, place, etc., the boundary points (which may be referred to as a first set of boundary points) and the interior points (which may be referred to as a first set of interior points) that represent or make up the existing/previous physical component at random locations within the point cloud. For example, the component module 211 may determine a random coordinate for point and may move the point to the random coordinate.

In one embodiment, the component module 211 may store the locations of the points for the existing/previous physical component (e.g., the locations/coordinates of the boundary points and the interior points) if the component module 211 randomly distributes the points in the initial point cloud. For example, prior to randomly distributing the points (e.g., the boundary points and the interior points) for the existing/previous physical component, the component module 211 may store the locations (e.g., coordinates within the point cloud) for those points. The original locations of the first set of interior points and the first set of interior points to random locations may be used by the movement module 215, as discussed in more detail below.

In one embodiment, the point cloud module 213 may generate one or more point clouds that may be used to generate, create, design, etc., physical components. For example, the point cloud module 213 may generate an input point cloud that may be provided to the DDPM 217 and the DDPM 217 may generate an output or component point cloud that represents a physical component, as discussed in more detail below.

In one embodiment, the point cloud module 213 may generate the input point cloud based on the point cloud generated by the component module 211. For example, the point cloud module 213 may receive the initial point cloud generated by the component module 211. The point cloud module 213 may add additional points to the initial point cloud to generate, obtain, etc., the input point cloud that will be provided to the DDPM 217. For example, the point cloud module 213 may add additional boundary points (which may be referred to as a second set of boundary points) and additional interior points (which may be referred to as a second set of interior points) to the initial point cloud. The point cloud module 213 may also randomly distribute the additional boundary points and the additional interior points (e.g., may place the additional boundary points and the additional interior points at random locations/coordinates) in the initial point cloud, resulting in the input point cloud.

As discussed above, the initial point cloud may include a first set of boundary points and a first set of interior points for the existing/previous physical component. In one embodiment, the point cloud module 213 may optionally move, relocate, etc., the first set of interior points and the first set of interior points to random locations within the input point cloud, rather than having the component module 211 perform that operation. If point cloud module 213 moves the first set of interior points and the first set of interior points to random locations (e.g., randomly distributes the first set of interior points and the first set of interior points to random locations), the point cloud module 213 may store the original locations of the first set of interior points and the first set of interior points. The original locations of the first set of interior points and the first set of interior points to random locations may be used by the movement module 215, as discussed in more detail below.

Generally, a denoising diffusion probabilistic model may be a type of generative model (e.g., a machine learning model, a generative machine learning model, etc.) that may be trained by iteratively and/or gradually/iteratively applying noise to an input (e.g., diffusion) and then learning how to gradually/iteratively remove noise that was added (e.g., denoising or reverse diffusion). A standard denoising diffusion probabilistic model may receive an input point cloud, and through multiple iterations, remove noise or denoise the input point cloud. For example, during each iteration, the denoising diffusion probabilistic model may move one or more points in the input point cloud to different locations/coordinates within the input point cloud. The resulting input point cloud (with the one or more points that have been moved) may then be provided to (e.g., fed into) the denoising diffusion probabilistic model as the input for the next iteration. A standard denoising diffusion probabilistic model may use points clouds with points that only include the coordinates of the points.

In one embodiment, the DDPM 217 may be an enhanced, augmented, improved, etc., denoising diffusion probabilistic model that uses point cloud where each point includes not only the coordinate/location of the point, but also the type of the point (e.g., boundary or interior). For example, each point in an input point cloud may include the coordinates/location of the point and may also indicate whether the point is a boundary point or an interior point. This may allow the DDPM 217 to learn (e.g., to be trained) where boundary points and/or interior points should be located/placed. For example, the DDPM 217 may be able to learn that location of interior points should be conditioned or based on boundary points (e.g., an interior point should be located on one side of a set of boundary points).

As discussed above, the component generation system 110 may generate a new physical component based on an existing/previous physical component. For example, the new physical component may include at least a portion of the existing/previous physical component, if not the entire existing/previous physical component. This may allow the component generation system 110 to generate new physical components that may still be able to interface with other existing components.

Also as discussed above, the input point cloud that is provided to the DDPM 217 includes boundary points (e.g., points that are located at boundaries, edges, perimeters, etc.) of a physical component and interior points (e.g., points that are located within the material of a physical component). The boundary points may be divided (e.g., logically and/or physical) into a first set of boundary points and a second set of boundary points, and the interior points may be divided into a first set of boundary points and a second set of boundary points. The first set of boundary points and the first set of interior points may be for the existing/previous physical component (e.g., may be associated with the existing/previous physical component). For example, the first set of boundary points and the first set of interior points may indicate the shape, geometry, dimensions, etc., of the existing/previous physical component. The second set of boundary points and the second set of interior points may be used by the DDPM 217 to generate the new physical component that is based on the existing/previous physical component. For example, the second set of boundary points and the second set of interior points may represent an addition, extension, attachment, etc., that may be combined with the existing/previous physical component to create the new physical component. The second set of boundary points and the second set of interior points may be associated with only the new physical component (e.g., may not be associated with and/or may not be a part of the existing/previous physical component).

In one embodiment, the DDPM 217 may generate an output or component point cloud that represents the new physical component, based on the input point cloud (e.g., the input point cloud generated by component module 211 and/or point cloud module 213). The DDPM 217 may generate the component point cloud in conjunction with the movement module 215 (or based on the movement module 215). For example, because the first set of boundary points and the first set of interior points are part of the existing/previous physical component, the locations of the first set of boundary points and the first set of interior points may be known. As the DDPM 217 performs iterations to denoise the input point cloud (e.g., to denoise the second set of boundary points and/or the second set of input points), the movement module 215 may move, relocate, shift, etc., the first set of boundary points and the first set of interior points back to their known or original positions. For example, the movement module 215 may move each point in the first set of boundary points and the first set of interior points back to its original position along a straight line, a curve, or some other path in each iteration of the DDPM 217 (e.g., may move each point a fixed distance along the line/path). In another example, the movement module 215 may move each point in the first set of boundary points and the first set of interior points back to its original position by a random distance in each iteration of the DDPM 217. The movement module 215 may use any appropriate function, equation, calculation, etc., to determine how (e.g., where and by what distance) to move each of the first set of boundary points and the first set of interior points.

In one embodiment, the DDPM 217 does not denoise the first set of boundary points and the first set of interior points (e.g., the DDPM 217 does not move any of the first set of boundary points and the first set of interior points). For example, the DDPM 217 may not be responsible for and/or may not move, relocate, adjust, etc., the points in the first set of boundary points and the first set of interior points. Instead, the DDPM 217 may use or rely on the movement module 215 to move the first set of boundary points and the first set of interior points.

In one embodiment, the DDPM 217 may denoise the second set of boundary points and/or the second set of input points which may form, represent, etc., the new portion of the new physical component (e.g., the new portion that may be added to the existing/previous physical component or portions of the existing/previous physical component). For example, in each iteration, the DDPM 217 may move one or more of points of the second set of boundary points and/or the second set of input points. The DDPM 217 may perform any appropriate number of iterations to denoise the input point cloud (e.g., to denoise the second set of boundary points and/or the second set of input points). For example, the DDPM 217 may be configured to perform a set number of iterations (e.g., 10 iterations, 50 iterations, 250 iterations, etc.). In another example, the DDPM 217 may determine whether to continue performing iterations based on a loss function, or some other parameter/condition.

In one embodiment, the DDPM 217 may be trained using a training module 219. The training module may use various point clouds to train the DDPM 217. For example, reference point clouds and training point clouds may be used to train the DDPM 217. The training point clouds may be point clouds that represent existing, previous, known, etc., physical components. Similar to the input point clouds, each reference point cloud may include boundary points and interior points to represent a respective existing/previous physical component.

In one embodiment, the training module 219 may generate the reference point clouds. For example, the training module 219 may obtain images, specification files, meshes, computer-aided drafting (CAD) files/information, and/or other information for various physical components. The training module 219 may analyze the images, specifications, CAD information, meshes, etc., to determine the geometry, shape, structure, etc., of a physical component and may determine where boundary points and interior points for the physical component should be located within a respective reference point cloud.

In one embodiment, the training module 219 may generate one or more training point clouds based on the reference point clouds. The training module 219 randomly distribute the boundary points and interior points in a reference point cloud to generate a training point cloud. Randomly distributing the boundary points and/or the interior points may be referred to as diffusion or as adding/applying noise to a point cloud. The training module 219 may apply various levels or amounts of noise to each training point cloud. For example, the training module 219 may perform a forward diffusion process that adds Gaussian noise to a reference point cloud based on sampled time steps from a uniform time schedule with different values of variance, to generate a training point cloud. The training module 219 may generate multiple training point clouds based on each reference point cloud (e.g., may generate tens, hundreds, thousands, etc., of training point clouds).

In one embodiment, the training module 219 may train the DDPM 217 by providing the DDPM 217 with the training point clouds as inputs. For example, the training module 219 may perform a denoising process/operation (e.g., a reverse diffusion process) to train the DDPM by to remove the noise from a training point cloud in order to generate or arrive back at a reference point cloud. The training module 219 may check whether the output of the DDPM is the same (or has a threshold number of similar points) as the reference point cloud.

As discussed above, designing, creating, generating, etc., new physical components (e.g., a door frame, a window, a hinge, a joint, etc.) to be used in a larger device/apparatus (e.g., a vehicle, an electronic device, etc.) is often a manual process that is performed by users, such as design engineers, mechanical engineers. The component generation system 110 may allow for the generation of new or novel physical components that is based on existing/previous physical components (e.g., based on a base physical component). The component generation system 110 may also streamline and/or automate this processed, allowing for faster and/or more efficient creation, generation, and/or design of new physical components.

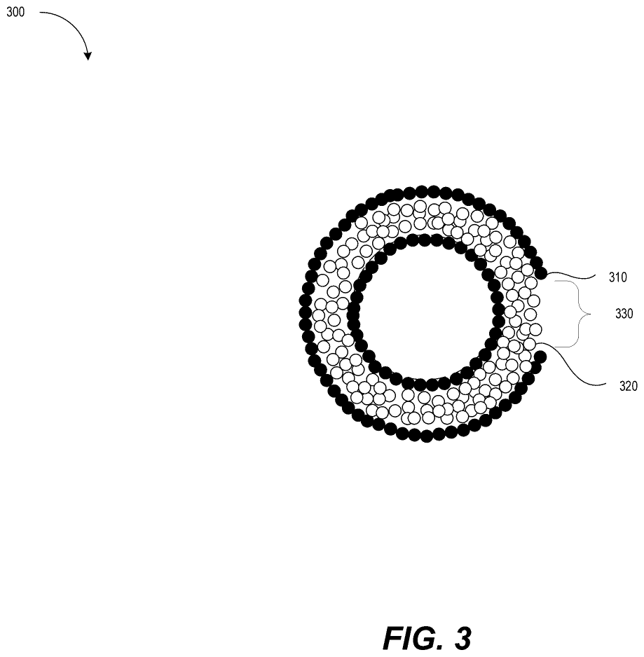

FIG. 3 is a diagram illustrating an example point cloud 300, in accordance with one or more embodiments of the present disclosure. As discussed above, a point cloud (e.g., an initial point cloud) may be generated for an existing/previous physical component or for a portion of an existing/previous physical component. For example, a component module (e.g., component module 211 illustrated in FIG. 2) may generate point cloud 300 based on images, specification files, and/or other data that indicates the dimension, shape, geometry, etc., of the existing/previous physical component (or portions of the existing/previous physical component). As illustrated in FIG. 3, point cloud includes two types of points, points 310 and points 320. Points 310 are represented by solid black circles and points 320 are represented by solid white circles. For simplicity, one of each type of point (e.g., one point 310 and one point 320) has been labeled in FIG. 3. In addition, although point clouds may be referred to herein as 3D point clouds, point cloud 300 illustrates a 2-dimensional (2D) point cloud for ease of illustration.

In one embodiment, the points 310 may represent boundary points and may be referred to as boundary points 310. As discussed above, boundary points are points that represent boundaries, edges, perimeters, etc., of a physical component. All of the points 310 may be referred to as a set of boundary points, a first set of boundary points, etc. The points 320 may represent interior points and may be referred to as a set of interior point, a first set of interior points, etc. As discussed above, interior points are points that located within a material of a physical component.

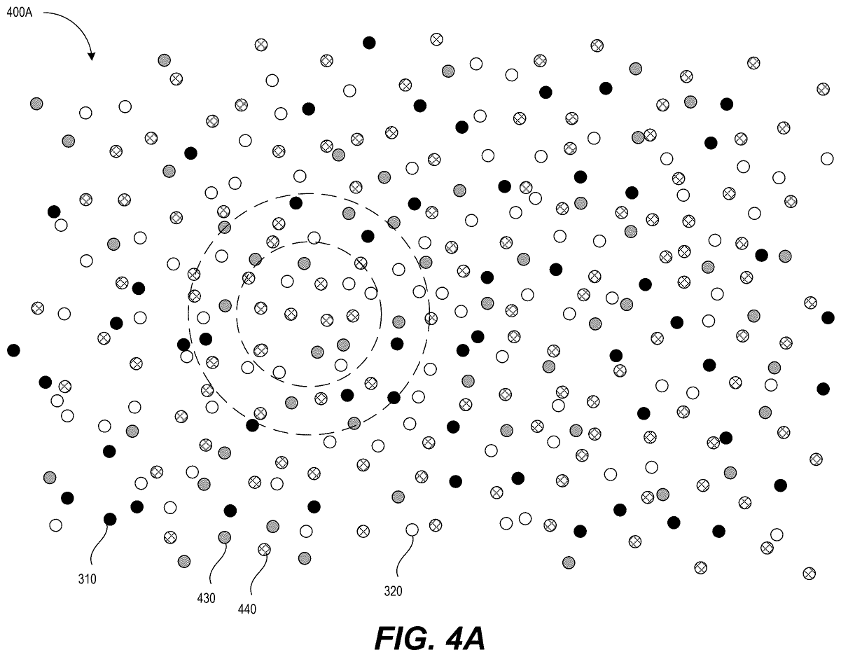

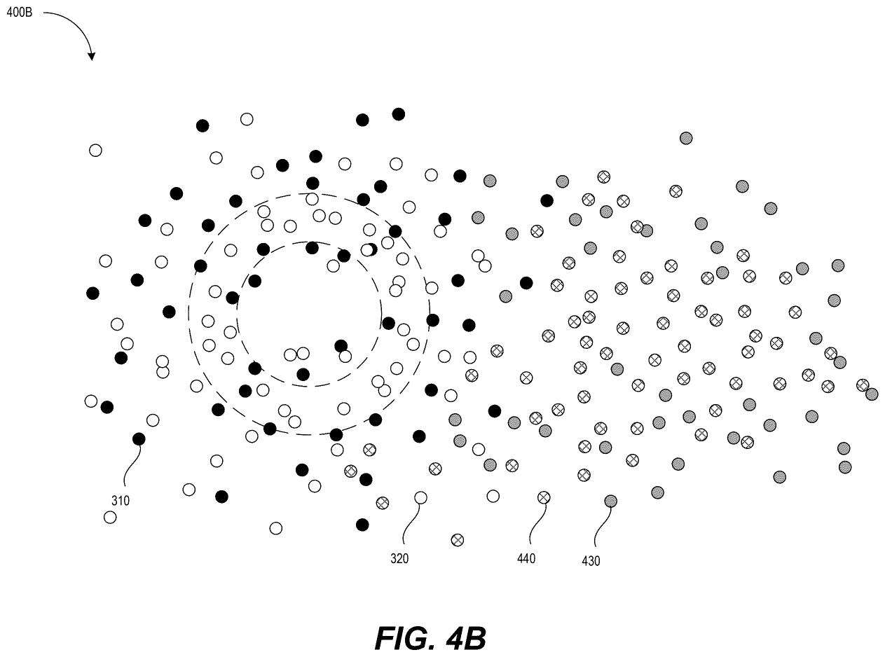

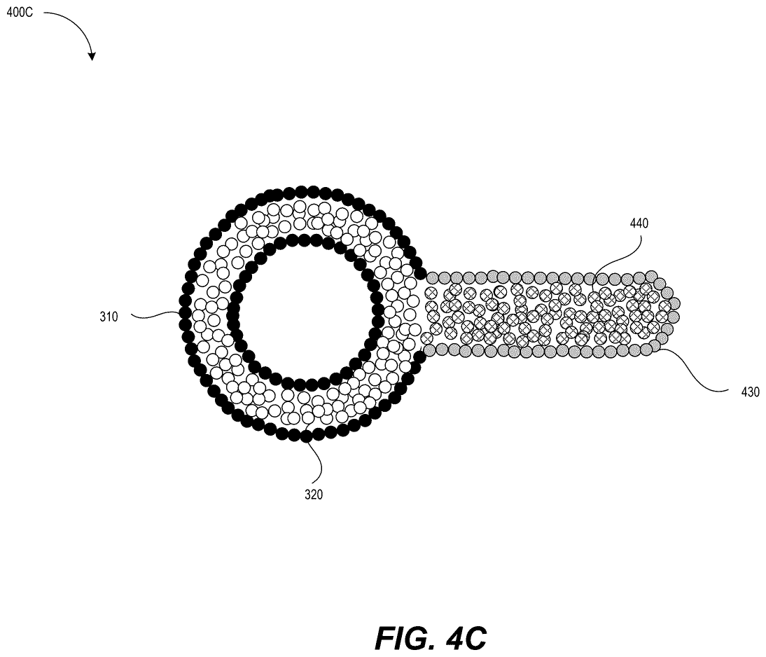

As illustrated in FIG. 3, the boundary points 310 include a gap 330 on the right side of the physical component. For example, there may be no boundary points 310 in the gap 330. The lack of boundary points 310 may allow a DDPM (e.g., DDPM 217 illustrated in FIG. 2) to attach a new component, portion, etc., to the existing/previous physical component, to generate a new physical component. For example, additional interior points (e.g., a second set of interior points) and/or additional boundary points (e.g., a second set of boundary points) may be added in the gap 330 to form the new physical components, as illustrated in FIG. 4C. Although gap 330 is illustrated in FIG. 3, other embodiments may not include a gap in the boundary points 310.

As discussed above, the locations of the boundary points 310 and the interior points 320 may be stored, recorded, etc., by the component module and/or a point cloud module (e.g., point cloud module 213 illustrated in FIG. 2). The locations (e.g., coordinates) of the boundary points 310 and the interior points may be used when generating an output point cloud (e.g., a component point cloud) for a new physical component, as discussed above and as illustrated in FIGS. 4A to 4C.

FIG. 4A is a diagram illustrating an example point cloud 400A, in accordance with one or more embodiments of the present disclosure. Point cloud 400A may be an example of an input point cloud that is provided to a DDPM (e.g., DDPM 217 illustrated in FIG. 2). As discussed above, a point cloud, such as an initial point cloud, may be generated for an existing/previous physical component or for a portion of an existing/previous physical component by a component module (e.g., component module 211 illustrated in FIG. 2). The initial point cloud may include boundary points 310 and interior points 320, as discussed above. For simplicity, one of each type of point (e.g., one point 310 and one point 320) has been labeled in FIG. 4A.

Boundary points 310 and the interior points 320 (e.g., the first set of boundary points and the first set of interior points associated with the existing/previous physical component) may be randomly distributed (e.g., moved to random locations) by a component module (e.g., component module 211 illustrated in FIG. 2) and/or a point cloud module (e.g., point cloud module 213 illustrated in FIG. 2), as illustrated in FIG. 4A. Furthermore, additional boundary points 430 and additional interior points 440 may be added to the initial point cloud (by the point cloud module) to generate the input point cloud 400A. Boundary points 430 are represented by gray circles and boundary points 440 are represented by the hatched circles. The additional boundary points 430 and the additional interior points may also be randomly distributed (e.g., located at random locations/coordinates) in the point cloud 400A. For simplicity, one of each type of point (e.g., one point 430 and one point 440) has been labeled in FIG. 4A.

As illustrated in FIG. 4A, the original locations of the boundary points 310 (e.g., the first set of boundary points) and the interior points 320 (e.g., the first set of interior points) are indicated by the dashed circles in FIG. 4A. For example, the original locations for boundary points 310 may be located on the dashed circles and original locations for the interior points 320 may be located between the dashed circuits. The locations (e.g., coordinates) of the boundary points 310 and the interior points may be used when generating an output point cloud (e.g., a component point cloud) for a new physical component, as discussed above and as illustrated in FIGS. 4B to 4C.

FIG. 4B is a diagram illustrating an example point cloud 400B, in accordance with one or more embodiments of the present disclosure. Point cloud 400B may be an example of an input point cloud after one or more iterations of denoising by a DDPM (e.g., DDPM 217 illustrated in FIG. 2). As discussed above an input point cloud (e.g., point cloud 400A) may be provided to the DDPM. The DDPM may denoise the input point cloud over multiple iterations. During each iteration, the DDPM may remove an amount of noise from the input point cloud (e.g., may move one or more points in the input cloud to a different location). After each iteration, the resulting input point cloud may be provided back to the DDPM as the input for the next iteration. Point cloud 400B may be an input point cloud for one of the iterations of denoising by the DDPM. Similar to FIG. 4A, the point cloud 400B includes boundary points 310 (e.g., a first set of boundary points), interior points 320 (e.g., a first set of interior points), boundary points 430 (e.g., a second set of boundary points), and interior points 440 (e.g., a second set of interior points). For simplicity, one of each type of point (e.g., one point 310, one point 320, one point 430, and one point 440) has been labeled in FIG. 4B.

As discussed above, the DDPM may denoise the boundary points 430 and/or the interior points 440 during each iteration performed by the DDPM. For example, when compared with FIG. 4A, many (if not all) of the boundary points 430 and the interior points 440 have been moved, relocated, adjusted, etc.). As the DDPM denoises the boundary points 430 and/or the interior points 440 a movement module (e.g., movement module 215 illustrated in FIG. 2) may also move the boundary points 310 and the interior points 320 towards their original locations (as indicated by the dashed circles). For example, when compared with FIG. 4A, many (if not all) of the boundary points 310 and the interior points 320 have been moved, relocated, adjusted, etc.).

FIG. 4C is a diagram illustrating an example point cloud 400C, in accordance with one or more embodiments of the present disclosure. Point cloud 400C may be an example of a component point cloud (e.g., an output point cloud) after the DDPM has denoised an input point cloud. As discussed above an input point cloud (e.g., point cloud 400A) may be provided to the DDPM. The DDPM may denoise the input point cloud over multiple iterations. After a certain number of iterations and/or after one or more conditions are met (e.g., after a loss function for the DDPM is satisfied), the DDPM may generate or output the point cloud 400C.

The point cloud 400C may represent a new physical component that may be based on an existing/previous physical component (illustrated in FIG. 3). For example, the left portion/side of the new physical component (represented by point cloud 400C) includes the circular/donut shaped portion of physical component illustrated in FIG. 3. In addition, the new physical component also includes an elongated portion (e.g., a handle) on the right side of the physical component. The elongated portion is generated by the DDPM, resulting in the new physical component.

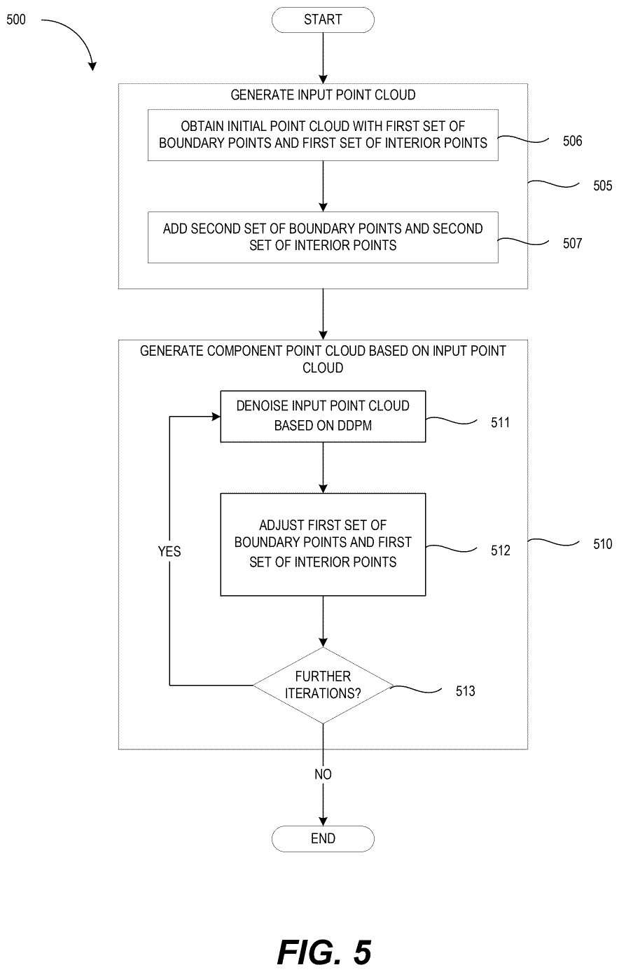

FIG. 5 is a flow diagram of a process for generating a physical component, in accordance with one or more embodiments of the present disclosure. Method 500 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the method 500 may be performed by one or more computing devices or computing systems (e.g., one or more of the component generation system 110, the component module 211, the point cloud module 213, the movement module 215, the DDPM 217, etc., illustrated in FIGS. 1-2).

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed, and other blocks (which may not be included in FIG. 5) may be performed between the blocks illustrated in FIG. 5.

Method 500 begins at block 505 where the method 500 may generate (or obtain) an input point cloud. As discussed above, the input point cloud may be provided to a DDPM (e.g., DDPM 217 illustrated in FIG. 2) as an input to generate a component point cloud (e.g., an output point cloud) that represents a new physical component. To generate the input point cloud, the method 600 may perform blocks 506 and 507.

At block 506, the method 500 may obtain an initial point cloud that represents an existing/previous physical component (e.g., a based physical component). The initial point cloud includes a first set of boundary points and a first set of interior points, as discussed above. At block 507, the method 500 may generate and/or add a second set of boundary points and a second set of interior points to the initial point cloud. The first set of boundary points, the first set of interior points, the second set of boundary points, and the second set of interior points may also be randomly distributed in the point cloud at block 507.

At block 510, the method 500 may generate a component point cloud (e.g., an output point cloud that represents a new physical component) based on the input point cloud. For example, the method 600 may use a DDPM and/or a movement module (e.g., DDPM 217 and/or movement module 215 illustrated in FIG. 2) to generate the component point cloud. To generate the component point cloud, the method 500 may perform blocks 511, 512, and 513.

At block 511, the method 500 may denoise the input point cloud (e.g., may move or adjust one or more points in the input point cloud). For example, the method 500 may provide the input point cloud as an input to the DDPM and the DDPM may perform denoising operations on the input point cloud. As discussed above, the DDPM may perform denoising operations on only the second set of boundary points and the second set of interior points. The DDPM may not be used to adjust the first set of boundary points and the first set of interior points. At block 512, the method 500 may adjust (e.g., move, relocate, etc.) the first set of boundary points and the first set of interior points. For example, the method 500 may use the movement module to move the first set of boundary points and the first set of interior points. At block 513, the method 500 may determine whether the DDPM should perform further iterations. For example, the method 500 may determine whether a threshold number of iterations have been performed. In another example, the method 500 may determine whether a loss function of the DDPM has been satisfied. If the DDPM should perform further iterations, the method 500 proceeds back to block 511. If the DDPM should not perform further iterations, the method 500 ends.

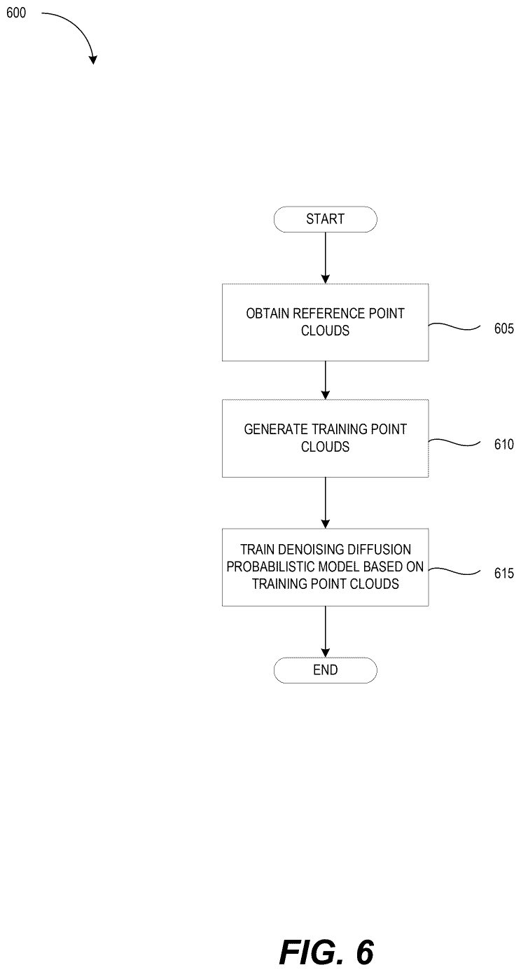

FIG. 6 is a flow diagram of a process for training a component generation system, in accordance with one or more embodiments of the present disclosure. Method 600 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the method 600 may be performed by one or more computing devices or computing systems (e.g., one or more of the component generation system 110, the DDPM 217, the training module 219, etc., illustrated in FIGS. 1-2).

With reference to FIG. 6, method 600 illustrates example functions used by various embodiments. Although specific function blocks (“blocks”) are disclosed in method 600, such blocks are examples. That is, embodiments are well suited to performing various other blocks or variations of the blocks recited in method 600. It is appreciated that the blocks in method 600 may be performed in an order different than presented, and that not all of the blocks in method 600 may be performed, and other blocks (which may not be included in FIG. 6) may be performed between the blocks illustrated in FIG. 6.

Method 600 begins at block 605 where the method 600 obtains reference point clouds. For example, the method 600 may obtain CAD files/data, meshes, images, etc., of existing/previous physical components. The method 600 may generate reference point clouds that represent the existing/previous physical components. The method 600 may also receive or retrieve the reference point clouds from a storage location (e.g., a storage device, a server computer, etc.). As discussed above, a point in general/standard point clouds may include the coordinate/location of the point. In one embodiment, a point in the reference point clouds may include not only the coordinate/location of the point, but may also include a type (e.g., a type indicator) that indicates whether the point is a boundary point or an interior point. Also as discussed above a boundary point may be a point that is located on an exterior, edge, surface, perimeter, etc., of the physical component. An interior point may be a point that is located within the material of the physical component.

At block 610, the method 600 may generate training point clouds. For example, the method 600 may generate the training point clouds based on the reference point clouds. The method 600 may randomly distribute the boundary points and interior points in a reference point cloud to generate a training point cloud. For example, the method 600 may perform a forward diffusion process that adds Gaussian noise to a reference point cloud based on sampled time steps from a uniform time schedule with different values of variance. At block 615, the method 600 may train a DDPM based on the training point clouds. For example, the method 600 may provide a training point cloud to the DDPM as an input and the DDPM may denoise the training point cloud. The method 600 may check whether the output of the DDPM is the same (or has a threshold number of similar points) as a reference point cloud.

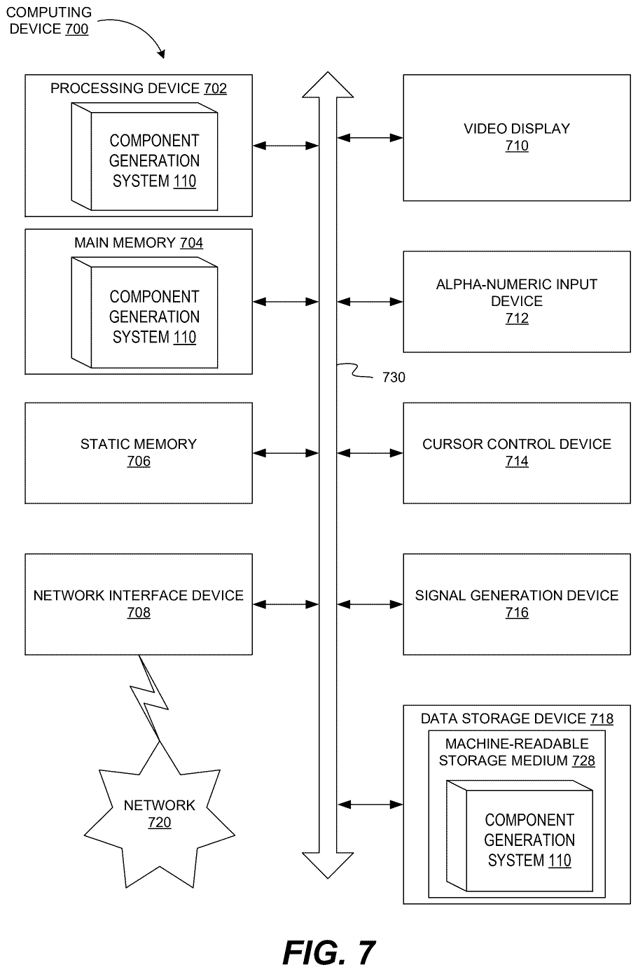

FIG. 7 is a block diagram of an example computing device 700 that may perform one or more of the operations described herein, in accordance with some embodiments. Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include a processing device 702 (e.g., a general-purpose processor, a PLD, etc.), a main memory 704 (e.g., synchronous dynamic random-access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also comprise one or more special-purpose processing devices such as an application specific integrated circuit (ASIC), a field programmable gate array (FPGA), a digital signal processor (DSP), network processor, or the like. The processing device 702 may be configured to execute the operations described herein, in accordance with one or more aspects of the present disclosure, for performing the operations and steps discussed herein.

Computing device 700 may further include a network interface device 708 which may communicate with a network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Data storage device 718 may include a computer-readable storage medium 728 on which may be stored one or more sets of instructions, e.g., instructions for carrying out the operations described herein, in accordance with one or more aspects of the present disclosure. Instructions implementing the different systems described herein (e.g., the component generation system 110, the component module 211, the point cloud module 213, the movement module 215, the DDPM 217, the training module 219, etc., illustrated in FIGS. 1-2) may also reside, completely or at least partially, within main memory 704 and/or within processing device 702 during execution thereof by computing device 700, main memory 704 and processing device 702 also constituting computer-readable media. The instructions may further be transmitted or received over a network 720 via network interface device 708.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Additional non-limiting examples, implementations, embodiments, etc., are described in APPENDIX A, which is hereby incorporated by reference in its entirety.

Unless specifically stated otherwise, terms such as “obtaining,” “determining,” “generating,” “calculating,” “performing,” “obtaining,” “updating,” “training,” “transforming,” “mapping,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

When an action, function, operation, etc., is described herein as being performed automatically, this may indicate that the action, function, operation, etc., may be performed without requiring human or user input, invocation, or interaction.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
generating an input point cloud comprising a first set of boundary points and a first set of interior points and a second set of interior points, wherein the first set of boundary points and the first set of interior points are associated with a first physical component and wherein each point in the input point cloud comprises a coordinate and a type indicator; and
generating a component point cloud based on the input point cloud and a denoising diffusion probabilistic model (DDPM), wherein the component point cloud represents a second physical component.

2. The method of claim 1, wherein the input point cloud further comprises a second set of boundary points and wherein the second set of boundary points are associated with only the second physical component.

3. The method of claim 1, wherein generating the input point cloud comprises:
distributing each of the first set of boundary points, the first set of interior points, and the second set of interior points at random locations within the input point cloud.

4. The method of claim 1, wherein the second set of interior points are associated with only the second physical component.

5. The method of claim 1, wherein generating the component point cloud comprises:
denoising the component point cloud through multiple iterations using the denoising diffusion probabilistic model, wherein the second set of interior points are adjusted by the denoising diffusion probabilistic model during each iteration of the multiple iterations.

6. The method of claim 5, wherein the first set of boundary points and the first set of interior points are not adjusted by the denoising diffusion probabilistic model during each iteration of the multiple iterations and wherein the first set of boundary points and the first set of interior points are adjusted by an adjustment module during each of the multiple iterations.

7. The method of claim 5, wherein the physical component is included as part of another apparatus during a manufacturing process.

8. The method of claim 7, wherein the first set of boundary points are adjusted towards a first set of positions within the component point cloud and the first set of interior points are adjusted towards a second set of positions within the component point cloud by an adjustment module during each of the multiple iterations.

9. The method of claim 8, wherein the first set of positions and the second set of positions are based on first physical component.

10. An apparatus, comprising:
a memory configured to store data; and
a processing device communicatively coupled to the memory, the processing device configured to:
generate an input point cloud comprising a first set of boundary points and a first set of interior points and a second set of interior points, wherein the first set of boundary points and the first set of interior points are associated with a first physical component and wherein each point in the input point cloud comprises a coordinate and a type indicator; and
generate a component point cloud based on the input point cloud and a denoising diffusion probabilistic model (DDPM), wherein the component point cloud represents a second physical component.

11. The apparatus of claim 10, wherein the input point cloud further comprises a second set of boundary points and wherein the second set of boundary points are associated with only the second physical component.

12. The apparatus of claim 10, wherein to generate the input point cloud the processing device is further configured to:
distribute each of the first set of boundary points, the first set of interior points, and the second set of interior points at random locations within the input point cloud.

13. The apparatus of claim 10, wherein the second set of interior points are associated with only the second physical component.

14. The apparatus of claim 10, wherein to generate the component point cloud the processing device is further configured to:
denoise the component point cloud through multiple iterations using the denoising diffusion probabilistic model, wherein the second set of interior points are adjusted by the denoising diffusion probabilistic model during each iteration of the multiple iterations.

15. The apparatus of claim 14, wherein the first set of boundary points and the first set of interior points are not adjusted by the denoising diffusion probabilistic model during each iteration of the multiple iterations and wherein the first set of boundary points and the first set of interior points are adjusted by an adjustment module during each of the multiple iterations.

16. The apparatus of claim 14, wherein the physical component is included as part of another apparatus during a manufacturing process.

17. The apparatus of claim 16, wherein the first set of boundary points are adjusted towards a first set of positions within the component point cloud and the first set of interior points are adjusted towards a second set of positions within the component point cloud by an adjustment module during each of the multiple iterations.

18. The apparatus of claim 17, wherein the first set of positions and the second set of positions are based on first physical component.

19. A non-transitory computer readable medium having instruction stored thereon that, when executed by a processing device, cause the processing device to:
generate an input point cloud comprising a first set of boundary points and a first set of interior points and a second set of interior points, wherein the first set of boundary points and the first set of interior points are associated with a first physical component and wherein each point in the input point cloud comprises a coordinate and a type indicator; and
generate a component point cloud based on the input point cloud and a denoising diffusion probabilistic model (DDPM), wherein the component point cloud represents a second physical component.

20. The non-transitory computer readable medium of claim 19, wherein the input point cloud further comprises a second set of boundary points and wherein the second set of boundary points are associated with only the second physical component.
